(19) United States
(12) Patent Application Publication
(10) Pub. No.: US 2006/0292982 A1
(43) Pub. Date: Dec. 28, 2006

(54) Method for accomodating timing drift between base stations in a wireless communications system

(75) Inventors: Henry Ye, Ledgewood, NJ (US); Lily Zhu, Parsippany, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/166,048

(22) Filed: Jun. 24, 2005

(51) Int. Cl. H04B 7/19

(52) U.S. Cl. 455/13.2; 342/357.1; 342/15; 701/213; 455/67.16

(57) ABSTRACT

A method is provided for controlling communications between a base station and a mobile device. The method comprises enlarging a search window in which a transmission is expected to be received in response to the absence of an external timing signal, such as when the global positioning system (GPS) is shut down. Additionally or alternatively, the method further comprises altering the timing of a received signal relative to a search window, such as by delaying the timing of the received signal to move the signal toward the center of the search window.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations distributed within an area to be serviced by the system. Various mobile devices within the area may then access the system and, thus, other interconnected telecommunications systems, via one or more of the base stations. Typically, a mobile device maintains communications with the system as it passes through an area by communicating with one and then another base station, as the mobile device moves. The process of moving from one base station to another is commonly referred to as a soft handoff and it may occur relatively often if the mobile device is moving rapidly. The mobile device may communicate with the closest base station, the base station with the strongest signal, the base station with a capacity sufficient to accept communications, etc.

For the handoff process to be effective, internal timing of the base stations and mobile devices are synchronized. Typically, the base stations are synchronized through Global Positioning System (GPS) signals. The mobile devices then obtain a timing reference by locking to the serving base station. In the scenario of a soft handoff, a mobile device communicates with more than one base station. This generally happens when the mobile device is at the edge of the serving cell so that it can also communicate with another base station or multiple base stations (e.g., non-serving cell(s)). Generally, the mobile device uses the time reference from the serving cell that should be synchronized with the timing of all other base stations. The synchronized timing allows the mobile devices and the base stations to “know” when they should look for transmissions, and when they are free to transmit. If a device is not synchronized, it may miss transmissions directed to it because it “looks” for a transmission at the wrong time. Similarly, an unsynchronized device may transmit at the wrong time.

Recently, it was announced that the GPS system may be shut down for a “period of time” in emergency situations, e.g., during times of war, terrorist attacks, and the like. When the. GPS system is shut down, each base station uses a local oscillator to generate an internal time reference. As a result, the time reference from one base station compared with the time reference from another base station can drift due to a variety of factors, such as different physical characteristics between different oscillators, and different oscillators being located in different temperature environments and thus behaving slightly differently. The longer the GPS system remains shut down, the bigger the drift or skew between two different base stations. Wireless communications systems typically have a preselected tolerance limit for the skew. Once the skew exceeds those limits, the mobile device will only be able to communicate with its serving base station and cannot support handoff, which is normally referred to as an island cell scenario. This situation can be particularly problematic if the mobile device is moving at even a moderate speed (e.g., 20 kmph) where soft handoffs may need to occur as frequently as every few seconds. As a result, the call may be dropped every few seconds.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one aspect of the instant invention, a method is provided for controlling communications in a wireless communications system. The method comprises enlarging a search window in which a transmission is expected to be received in response to the absence of an external timing signal.

In another aspect of the instant invention, a method is provided for controlling communications in a wireless communications system. The method comprises altering the timing of a received signal relative to a search window.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention;

FIG. 2 depicts a block diagram of one embodiment of a base station and a mobile device in the communications system of FIG. 1; and

FIG. 3 depicts a flow chart of one embodiment of a method that may be used to control a search window of a BS in which transmissions are expected to be received by the mobile devices and base stations of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

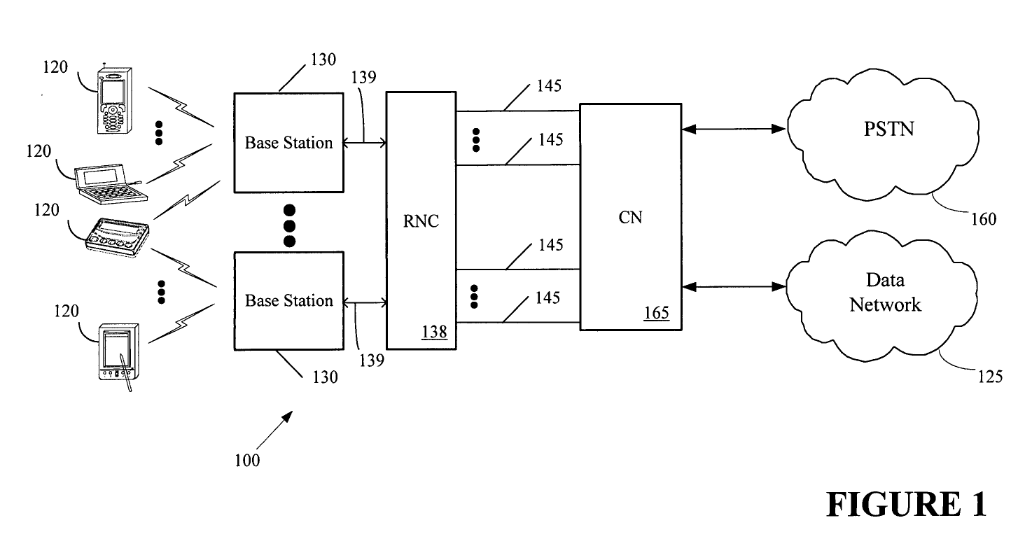

Turning now to the drawings, and specifically referring to FIG. 1, a communications system 100 is illustrated, in accordance with one embodiment of the present invention. For illustrative purposes, the communications system 100 of FIG. 1 is a Code Division Multiple Access (CDMA) system, although it should be understood that the present invention may be applicable to other systems that support data and/or voice communications, such as 1X EV-DO. The communications system 100 allows one or more mobile devices 120 to communicate with a data network 125, such as the Internet, and/or a Publicly Switched Telephone Network (PSTN) 160 through one or more base stations 130. The mobile device 120 may take the form of any of a variety of devices, including cellular phones, personal digital assistants (PDAs), laptop computers, digital pagers, wireless cards, and any other device capable of accessing the data network 125 and/or the PSTN 160 through the base station 130.

In one embodiment, a plurality of the base stations 130 may be coupled to a Radio Network Controller (RNC) 138 by one or more connections 139, such as T1/EI lines or circuits, ATM circuits, cables, optical digital subscriber lines (DSLs), and the like. Although one RNC 138 is illustrated, those skilled in the art will appreciate that a plurality of RNCs 138 may be utilized to interface with a large number of base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each user 120 and for each sector supported by each of the base stations 130.

The RNC 138 is also coupled to a Core Network (CN) 165 via a connection 145, which may take on any of a variety of forms, such as T1/EI lines or circuits, ATM circuits, cables, optical digital subscriber lines (DSLs), and the like. Generally the CN 165 operates as an interface to a data network 125 and/or to the PSTN 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the mobile devices 120 and the data network 125 and/or the PSTN 160. It should be understood, however, that the configuration of the communications system 100 of FIG. 1 is exemplary in nature, and that fewer or additional components may be employed in other embodiments of the communications system 100 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

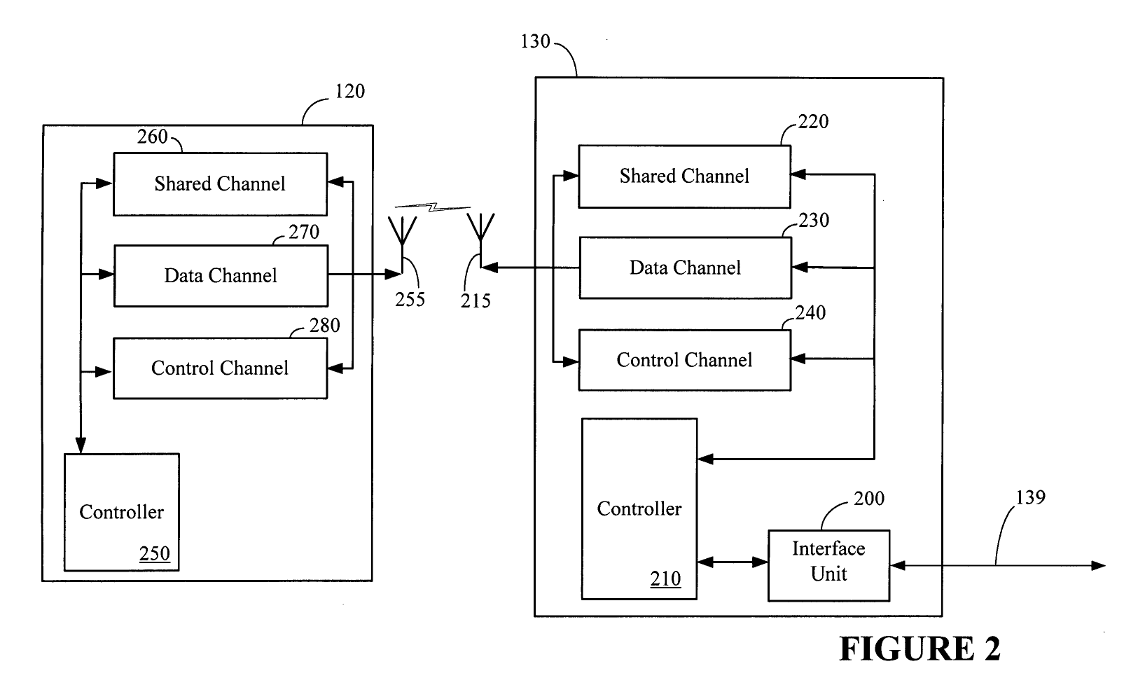

Referring now to FIG. 2, a block diagram of one embodiment of a functional structure associated with an exemplary base station 130 and mobile device 120 is shown. The base station 130 includes an interface unit 200, a controller 210, an antenna 215 and a plurality of channels, such as a shared channel 220, a data channel 230, a control channel 240, and the like. The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels 220, 230, 240 and to communicate at least portions of the received information to the RNC 138 via the interface unit 200.

The mobile device 120 shares certain functional attributes with the base station 130. For example, the mobile device 120 includes a controller 250, an antenna 255 and a plurality of channels, such as a shared channel 260, a data channel 270, a control channel 280, and the like. The controller 250 generally operates to control both the transmission and reception of data and control signals over the antenna 255 and the plurality of channels 260, 270, 280.

Normally, the channels 260, 270, 280 in the mobile device 120 communicate with the corresponding channels 220, 230, 240 in the base station 130. Under the operation of the controllers 210, 250, the channels 220, 260; 230, 270; 240, 280 are used to effect a controlled scheduling for communications from the mobile device 120 to the base station 130.

Typically, operation of the channels 260, 270, 280 in the mobile device 120 and the corresponding channels 220, 230, 240 in the base station 130 have been time slot (PCG) operated. For example, in each forward link (FL) time slot, control information meant for all of the mobile devices 120 connected to the base station 130 is transmitted, in addition to user data for at least a portion of those mobile devices 120, all from a single base station antenna. Typically, the control information may include information regarding the timing and rate at which the mobile devices 120 are permitted to transmit. In one aspect of the instant invention, a method that can significantly increase the system's tolerance limit with respect to skew or drift of the timing of such signals during a soft handoff is proposed. Generally, during a soft handoff, the mobile device 120 will attempt to communicate with its current serving base station and a second or target base station. If a timing difference exists between the target base station 130 and the mobile device 120, then the mobile device 120 may transmit signals to the target base station 130 at a time that is outside of a window in which the target base station 130 expects to receive a signal from the mobile device 120. Thus, the target base station will not properly receive the signal from the mobile device 120 and the handoff procedure will fail.

In one embodiment of the instant invention, the tolerance limit may be increased using two methodologies. First, programmable values for a search window for both the mobile device 120 and the base station 130 may be increased when the GPS system is shut down. The larger search windows provide a larger tolerance level for the mobile device 120. However, the tolerance level at the base station 130 can be still relatively low even if the search window of the base station 130 is maximized. The signal from mobile device 120 to the base station 130 is commonly located closer to the beginning of the base station search window. Therefore, the tolerance level for drifting toward one direction is relatively weak while the tolerance level for drifting toward the other direction is substantially stronger.

In the second methodology, an artificial delay may be introduced into the reverse link (i.e., from mobile device 120 to the base station 130) signals. The delay shifts the signal from mobile device 120 to the base station 130 toward the center of the base station search window. Since the base station search window is already increased or maximized in the first methodology discussed above, the tolerance level for drifting in either direction is better balanced and jointly optimized. The artificial delay can be introduced at any of several point between the base station antennas and the base station baseband receiver processors, including places such as antenna cable, radio, channel card, and the baseband receiver processor that is often implemented in hardware, such as in an Application-Specific Integrated Circuit (ASIC), a Field-Programmable Fate Array (FPGA), a Digital Signal Processor (DSP), and the like. One location at which the artificial delay may be introduced is within the channel card FPGA. The artificial delay may be programmable based on cell radius. This approach generally centers the signals from mobile device to the base station within the base station search window. As a result, the system can support soft handoff without GPS signals for a substantially longer time.

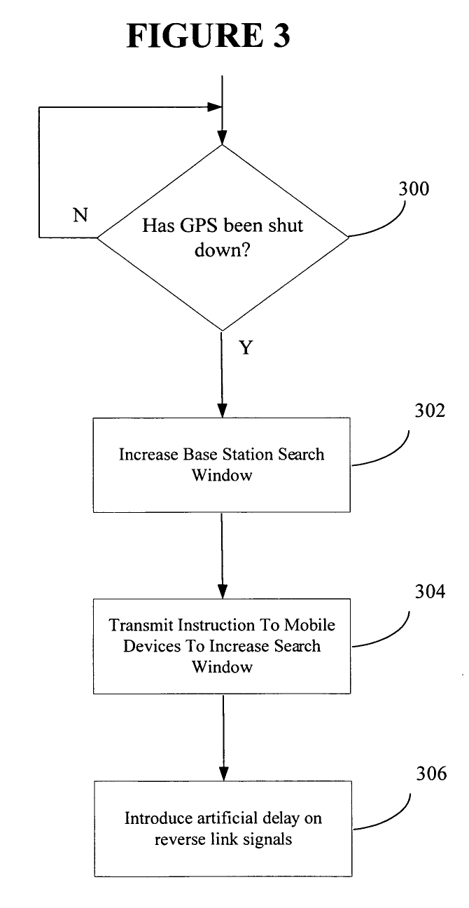

Turning now to FIG. 3A, a flow chart of a method that may be employed by the base station 130 to enhance the tolerance limits during times when the GPS is shut down is shown. The process begins at block 300 with the base station 130 determining that the GPS has been shut down. The process of determining that the GPS has been shut down may be automated or it may be the result of a manual signal generated by an operator associated with the wireless system 100. For example, the base stations 130 may be configured to assume that the GPS has been shut down if no timing signal is received for a preselected duration of time. At block 302, the base station 130 responds to the GPS being shut down by increasing the search window of the base station 130. In one embodiment of the instant invention, the base station 130 increases the search window to its maximum allowable value. With the search window of the base station 130 increased, any mistimed signals transmitted by the mobile device 120 are more likely to still fall within the now larger search window of the base station 130 and still be properly detected and received.

At block 304, the base station 130 sends a control signal to the mobile devices 120, instructing the mobile devices 120 to increase the search window of the mobile devices 120. In one embodiment of the instant invention, the base station 130 may instruct the mobile devices 120 to increase the mobile device search window to its maximum allowable value. With the search window of the mobile devices 120 increased, any mistimed signals transmitted by the base stations 130 are more likely to still fall within the now larger search window of the mobile device 120 and still be properly detected and received.

At block 306, the artificial delay is introduced on the reverse link to more centrally locate the mobile device transmission within the base station search window. The magnitude of the delay may be static or dynamic. In one embodiment of the instant invention, a known preprogrammed delay may be activated to introduce a delay having a magnitude that is based on statistical data regarding how much delay, on average, is needed to generally center the mobile device transmissions within the search window of the base station 130. Alternatively, a delay related to the size of the cell may be used. This preprogrammed delay may remain substantially unchanged during the entire time that the GPS is shut down.

The magnitude of the introduced artificial delay may be based on statistics or the delay measurements of at least some of the mobile devices 120 that have communicated or are communicating with that base station 130. Or, for another example, the artificial delay can be based on the cell size.

In an alternative embodiment, it may be useful to periodically vary the delay based on measurements of the signals received from the mobile devices 120. For example, it may be useful to periodically determine if a signal received from a mobile device 120 is substantially centered within the base station search window. If a significant deviation is detected, the base station could adjust the artificial delay to re-center the transmission in the search window. In the dynamic approach, it may be particularly useful to perform these measurements on mobile devices 120 that are entering soft handoff from another cell. In this way, any drift in the timing signals generated by adjacent base stations 130 may be accounted for to further extend the duration of time that the communications system may properly operate in the absence of the GPS.

It should be recognized that the data flow in FIG. 3 does not necessarily indicate that the procedures in blocks 302, 304, and 306 are triggered serially in the illustrated, or any particular, order. Indeed, once the GPS is detected in block 300, all these three procedures may be triggered quickly, and in some applications, as soon as possible. The procedure in block 304 is sufficient to increase the tolerance level for the mobile device 120 while the procedures in blocks 302 and 306 are both useful to increase the tolerance level for the base station 130.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling communications in a wireless communications system, comprising:
enlarging a search window in which a signal is expected to be received in response to the absence of an external timing signal.

2. A method, as set forth in claim 1, wherein enlarging the search window in which the signal is expected to be received in response to the absence of the external timing signal further comprises enlarging the search window in which the signal is expected to be received in response to the absence of a global positioning signal.

3. A method, as set forth in claim 1, further comprising altering the timing of the signal relative to the search window.

4. A method, as set forth in claim 3, wherein altering the timing of the signal relative to the search window further comprises altering the timing of the signal to move the signal toward the center of the search window.

5. A method, as set forth in claim 3, wherein altering the timing of the signal relative to the search window further comprises delaying the timing of the signal to move the signal toward the center of the search window.

6. A method, as set forth in claim 3, wherein altering the timing of the signal relative to the search window further comprises delaying the timing of the signal by a predetermined amount of time.

7. A method, as set forth in claim 3, wherein altering the timing of the signal relative to the search window further comprises delaying the timing of the signal by a predetermined amount of time related to the distance over which the signal is transmitted.

8. A method, as set forth in claim 3, wherein altering the timing of the signal relative to the search window further comprises delaying the timing of the signal by an amount of time related to the timing of a previous signal relative to the search window.

9. A method for controlling communications in a wireless communications system, comprising:
altering the timing of a received signal relative to a search window.

10. A method, as set forth in claim 9, further comprising enlarging the search window in which the signal is expected to be received in response to the absence of an external timing signal.

11. A method, as set forth in claim 10, wherein enlarging the search window in which the signal is expected to be received in response to the absence of the external timing signal further comprises enlarging the search window in which the signal is expected to be received in response to the absence of a global positioning signal.

12. A method, as set forth in claim 9, wherein altering the timing of the received signal relative to the search window further comprises altering the timing of the received signal to move the received signal toward the center of the search window.

13. A method, as set forth in claim 9, wherein altering the timing of the received signal relative to the search window further comprises delaying the timing of the received signal to move the received signal toward the center of the search window.

14. A method, as set forth in claim 9, wherein altering the timing of the received signal relative to the search window further comprises delaying the timing of the received signal by a predetermined amount of time.

15. A method, as set forth in claim 9, wherein altering the timing of the received signal relative to the search window further comprises delaying the timing of the received signal by a predetermined amount of time related to the distance over which the received signal is transmitted.

16. A method, as set forth in claim 9, wherein altering the timing of the received signal relative to the search window further comprises delaying the timing of the received signal by an amount of time related to the timing of a previous signal relative to the search window.
